(19) United States
(12) Patent Application Publication
(10) Pub. No.: US 2004/0194307 A1
(43) Pub. Date: Oct. 7, 2004

(54) Manufacturing pistons

(76) Inventor: Samantha Isobelle Barnes, Rugby (GB)

Correspondence Address: Howard and Howard, The Pinehurst Office Center Ste 101, 39400 Woodward Avenue, Bloomfield Hills, MI, 48304-5151, US

(21) Appl. No.: 10/478,613

(22) PCT Filed: May 21, 2002
(86) PCT No.: PCT/GB02/02362

(30) Foreign Application Priority Data
May 24, 2001 (GB) 0112865.1

(51) Int. Cl. B21K 1/18; B23P 11/00

(52) U.S. Cl. 29/888.044

(57) ABSTRACT

A piston is manufactured with functional recesses (6, 7, 8) thereof formed from property improving material (18b, 18c, 18d). A blank (10) defines a mounting recess (12, 14, 16) and a quantity of said property-improving material (18b, 18c, 18d) is secured within said mounting recess. Said functional recess (6, 7, 8) is machined out of said quantity of property-improving material. The process for securing said property-improving material (18b, 18c, 18d) comprises forming a rod (20, 22, 34) from a material which on plasticisation under heat and pressure forms said property-improving material, inserting an end of the rod into said mounting recess, and rotating said rod in contact with a surface of the mounting recess (12, 14, 16), while applying force to the rod to feed it into the mounting recess. The rotational speed of said rod and the force applied thereto being controlled so that frictional heat is generated between the rod and the blank, causing plasticisation of the material of the rod, thereby, upon solidification converting it into said property-improving material (18b, 18c, 18d).

This invention is concerned with a method of manufacturing a piston for use in an internal combustion engine.

Pistons for use in internal combustion engines comprise a crown portion, a skirt portion, and a mounting portion on which a gudgeon pin is mounted, the gudgeon pin serving to connect the piston to a connecting rod of the engine. The crown portion has an upper surface which extends across a cylinder in which the piston makes reciprocating movement, being guided in its movement by the skirt portion of the piston.

The upper surface of the crown portion borders a combustion chamber in which combustion events take place to drive the piston downwardly in its cylinder. Hence, the upper surface of the crown portion is subjected to high forces and temperatures caused by the combustion events. In many pistons, the crown portion defines a combustion recess which has an opening in the upper surface of the piston. The combustion recess has the purpose of improving the combustion events by controlling the flow of gases in the combustion chamber. The side surface portion of the crown portion of the piston, ie the surface portion thereof which extends generally parallel to the wall of the cylinder, defines one or more recesses in the form of grooves extending around the piston. These grooves are for containing piston rings which seal the gap between the piston and the wall of the cylinder. The side surface portion of the crown portion of the piston is also subjected to high forces and temperatures.

The gudgeon pin mounting portion of a piston is often formed by two aligned cylindrical recesses, each of which receives one end portion of the gudgeon pin. The surfaces of these recesses are subject to considerable stresses during the operation of the piston.

Hence, a typical piston has one or more functional recesses in the form of a combustion recess, one or more ring-receiving grooves, and one or two gudgeon pin-receiving recesses. These recesses are all problem areas in the operation of a piston due to the conditions applied thereto.

Pistons are usually manufactured by forming a blank, usually by casting metal (often an alloy of aluminium). The blank is then machined to its final shape. The blank is arranged to form at least a crown portion of the piston but often includes the skirt and mounting portions in an integral structure. Where the structure is not integral, the skirt and/or mounting portions may be formed as one or more further blanks which are secured, eg by welding, to the blank forming the crown portion. It is also possible for the gudgeon pin to join the crown portion to the skirt portion giving an articulated piston.

In order to improve the properties of problem areas of a piston, ie those adjacent to functional recesses as discussed above, it is known to utilise an insert of a material which has improved properties over those of the remainder of the piston. For example a high fatigue-strength or wear-resistant material can form at least part of the bounding surface of the ring groove or of the combustion recess or can form a lining for the gudgeon pin receiving recess which is more stress resistant than the remainder of the piston material. Such an insert can either be cast-in, ie be placed in a cavity and have the piston blank cast around it, or be attached to the blank after casting. Both methods of providing an insert are, however, awkward. Another technique is to re-melt portions of the blank to give them a different, higher fatigue-strength micro-structure, but this is also awkward and is difficult to apply to more than a thin surface layer. Furthermore, some inserts or micro-structures are difficult to machine to the final form of the piston.

It is an object of the present invention to provide an improved method of manufacturing a piston in which a region of a material having different properties, eg high fatigue-strength or wear-resistance, from the remainder of the piston is provided in a selected surface portion of the piston.

The invention provides a method of manufacturing a piston for use in an internal combustion engine, the piston defining at least one functional recess having an opening in a surface portion of said piston, the piston having a body which is formed from cast metal, the functional recess having a surface which is at least partially formed from a property-improving material which is secured to the body, the method comprising forming a blank from cast metal, the blank defining at least one mounting recess which has an opening in a surface portion of the blank, the method also comprising securing a quantity of said property-improving material to said blank within said mounting recess, and machining said functional recess of the piston at least partially out of said quantity of property-improving material, characterised in that the process for securing said property-improving material to the blank comprises forming a rod from a material which on plasticisation under heat and pressure is formed into said property-improving material, inserting an end of the rod into said mounting recess, and rotating said rod in contact with a surface of the mounting recess, while applying force to the rod to feed it into the mounting recess, the rotational speed of said rod and the force applied thereto being controlled so that frictional heat is generated between the rod and the blank, causing at least partial plasticisation of the material of the rod, thereby converting at least part of the material of the rod into said property-improving material, and also causing plasticisation of the material of the blank adjacent to the rod, so that plasticised material of the rod and the blank merge and secure the property-improving material to the blank.

A method according to the invention enables a property-improving material to be utilised for at least part of the surface of a functional recess of a piston in a more precise and less awkward manner than in existing methods. Furthermore, different property improvements can be achieved in different parts of the same piston without complicating the casting process. Thus, a piston may have improved heat-resistance around its combustion recess, improved wear-resistance around its ring grooves, and improved stress resistance around its gudgeon pin-receiving recesses. The whole of the material of the rod which enters the mounting recess may be plasticised, or only a part thereof, the part which is not plasticised may be machined away.

The securing process by which the property-improving material is secured to the body in a method according to the invention is similar in principle to the process known as friction hydro pillar processing described in WO 93/04813 and referred to in U.S. Pat. No. 5,975,406. This process is disclosed as being primarily intended for use on steel and as a way of repairing holes formed in workpieces during a friction stir welding process in which work pieces are welded together. Friction hydro pillar processing essentially involves rotating a consumable rod in contact with the surface of a generally cylindrical hole to be filled, while applying a load to the rod, thereby generating continuously a plasticised layer of material. The rotating rod heats by friction and the plasticised layer rises along the hole leaving beneath it a dynamically recrystallised material which fills the hole. Friction stir welding itself is described in WO 93/10935 and WO 95/26254 and U.S. Pat. No. 5,460,317. In addition to its use as a hole repairing technique, WO 93/04813 discloses that friction hydro pillar processing can be utilised for plasticising material in order to mould it into desired shapes, to clad a workpiece or provide a lining in a hollow workpiece.

In a method according to the invention, the mounting recess may be a blind recess of generally cylindrical or frusto-conical form having a circular or annular opening in an end surface of a piston crown-forming portion of the blank. In this case, the functional recess may be a combustion recess of the piston having at least a rim portion thereof machined out of the property-improving material. Alternatively, said functional recess may be a piston ring-receiving groove of the piston. In this case, the method comprises machining a side surface portion of said piston crown-forming portion, thereby exposing said property-improving material in said mounting recess, and machining the groove at least partially into said exposed material.

Instead of a blind recess, the mounting recess may be a through recess of generally cylindrical or frusto-conical form having circular openings at either end in side surfaces of a gudgeon pin-mounting portion of the blank. In this case the method comprises at least partially closing one of said openings with a member, the member being selected so that, when said rod is introduced into the mounting recess through the other opening and, while rotating, engages the member, frictional heat is generated between the rod and the member but the member is not plasticised. Preferably, where said functional recess is aligned with a similar recess so that these two recesses can together receive a gudgeon pin, said blank defining two aligned mounting recesses, said member is positioned in a recess in said mounting portion of the blank (the recess which receives the connecting rod) so that the member closes openings of both mounting recesses and can be engaged by rods in both mounting recesses.

Said rod may be hollow and contain a core which acts to contain the plasticised material during the securing process.

Said mounting recess may be provided with at least one re-entrant surface portion arranged so that plasticised material enters said re-entrant portion during the securing process so that material in said re-entrant portion keys said property-improving material into said blank.

The blank or the rod may be provided with surface features such as ribs on their contacting surfaces to increase the friction therebetween. These surface features are useful for distributing surface materials such as oxides into the surrounding material, this being particularly advantageous where the cast metal is aluminium.

There now follows a detailed description, to be read with reference to the accompanying drawings, of four methods of manufacturing a piston which are illustrative of the invention.

In the drawings:

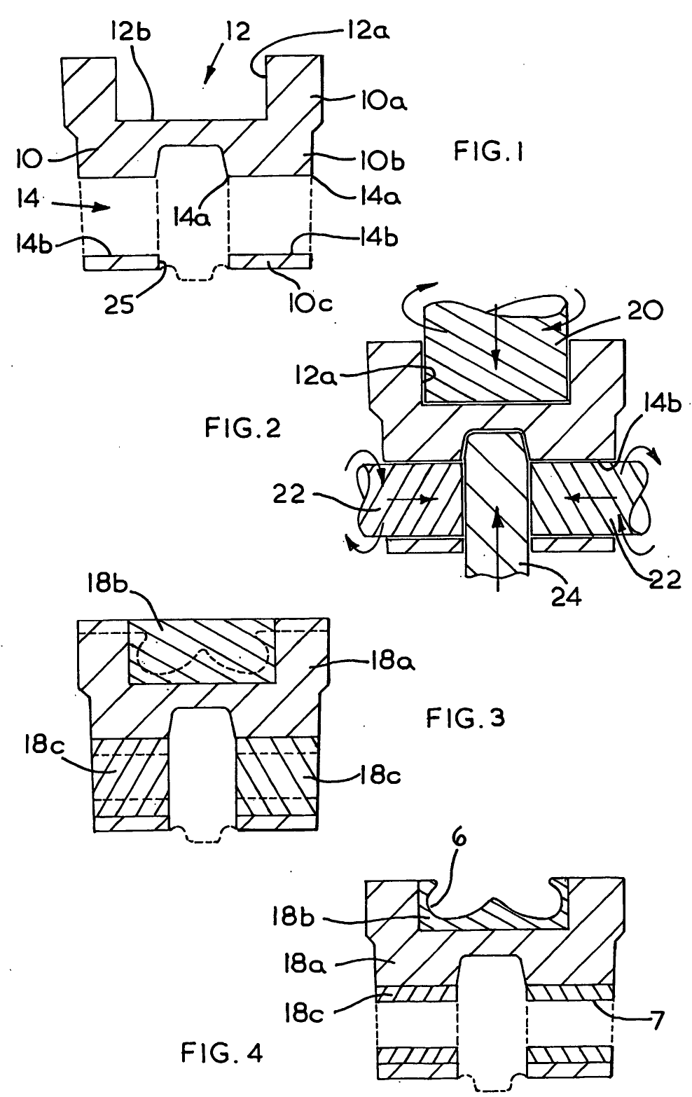

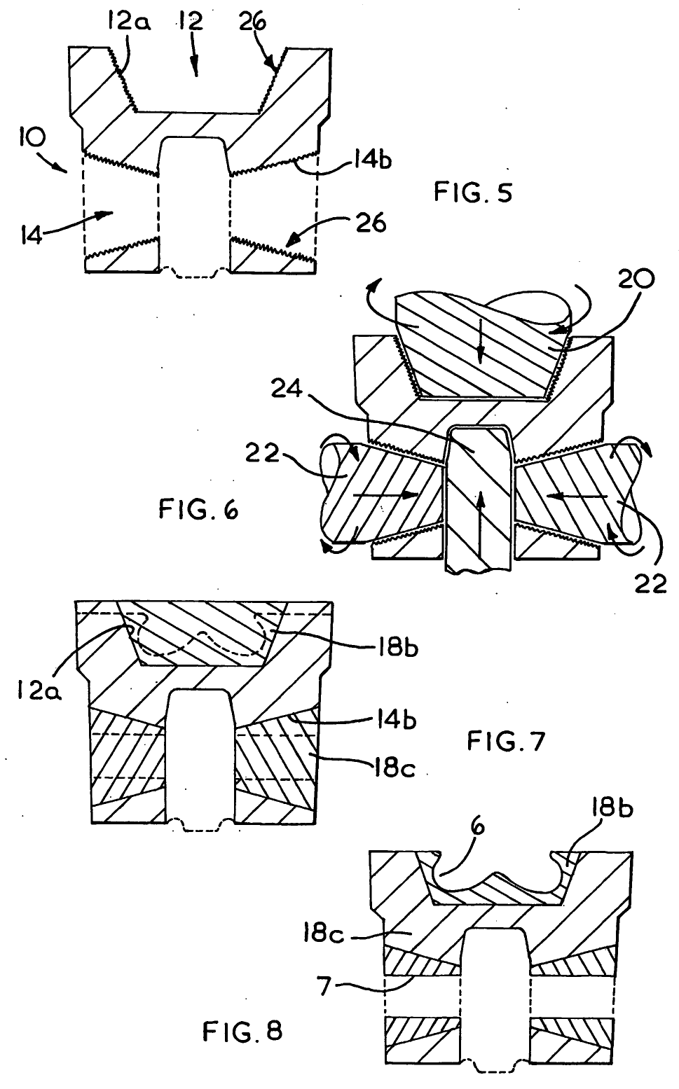

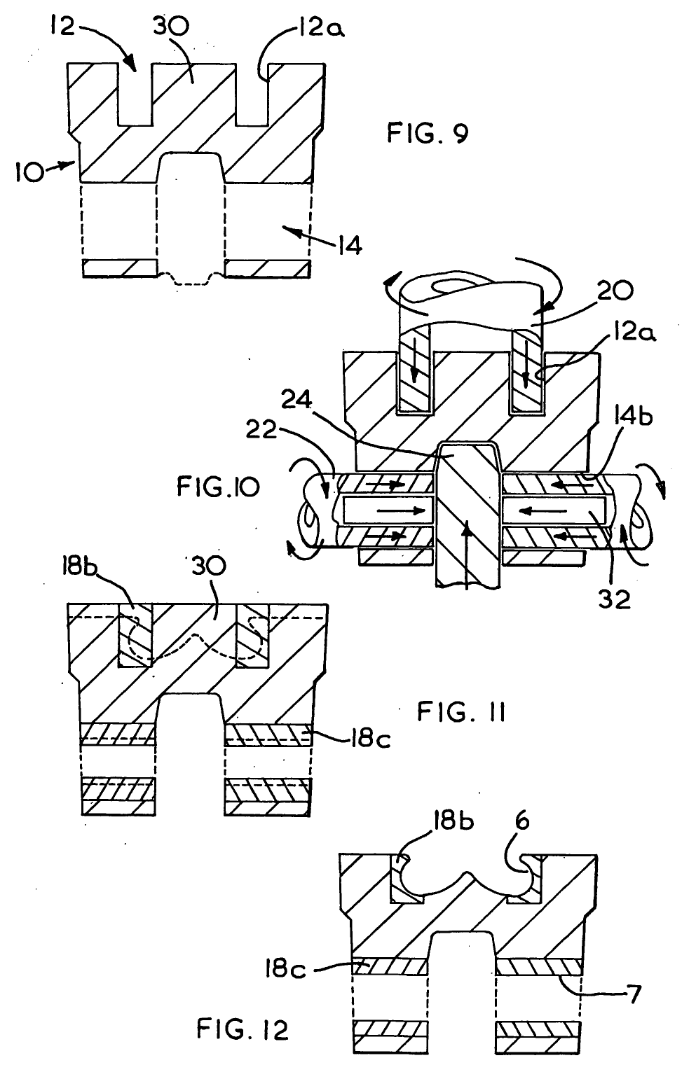

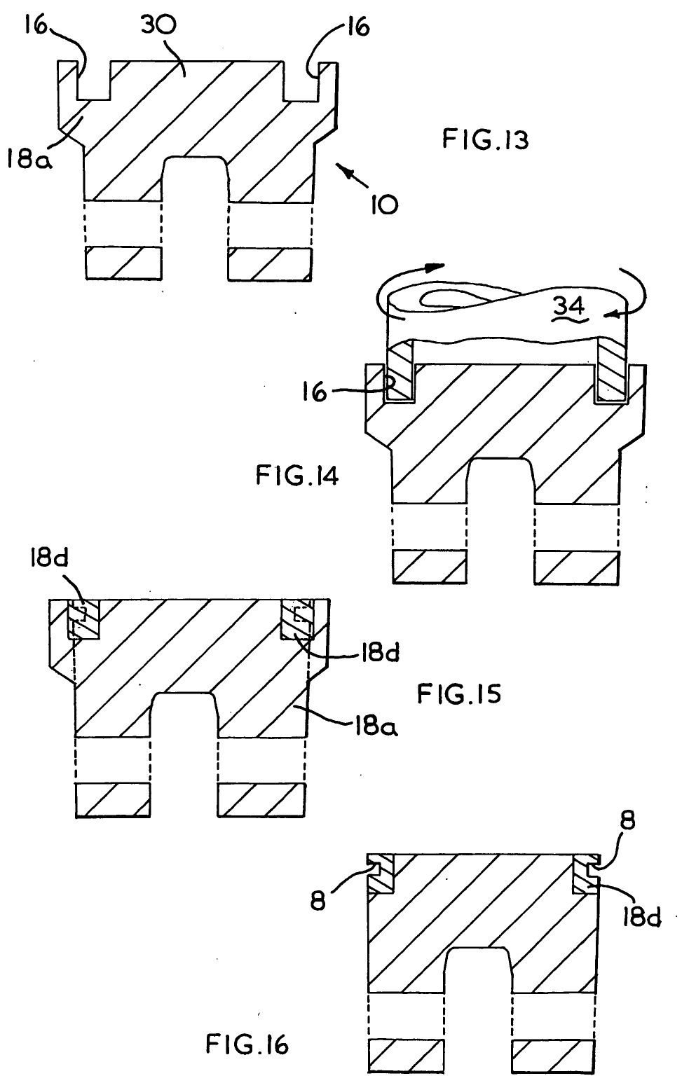

FIGS. 1 to 4 are vertical cross-sectional views taken through a piston blank illustrating successive stages in the first illustrative method;

FIGS. 5 to 8, 9 to 12 and 13 to 16 are similar views to FIGS. 1 to 4 but, respectively, illustrate stages in the second, third and fourth illustrative methods;

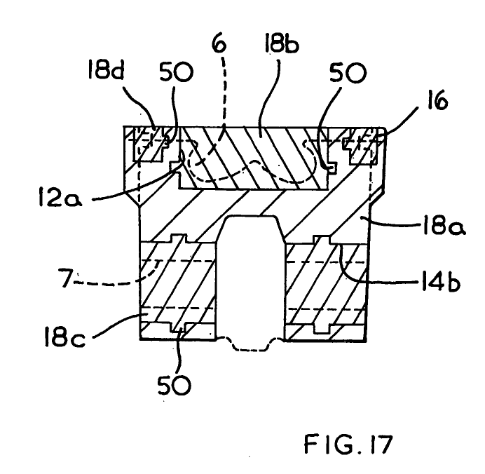

FIG. 17 is a view similar to FIGS. 1 to 16 but illustrating a modification of the illustrative methods; and

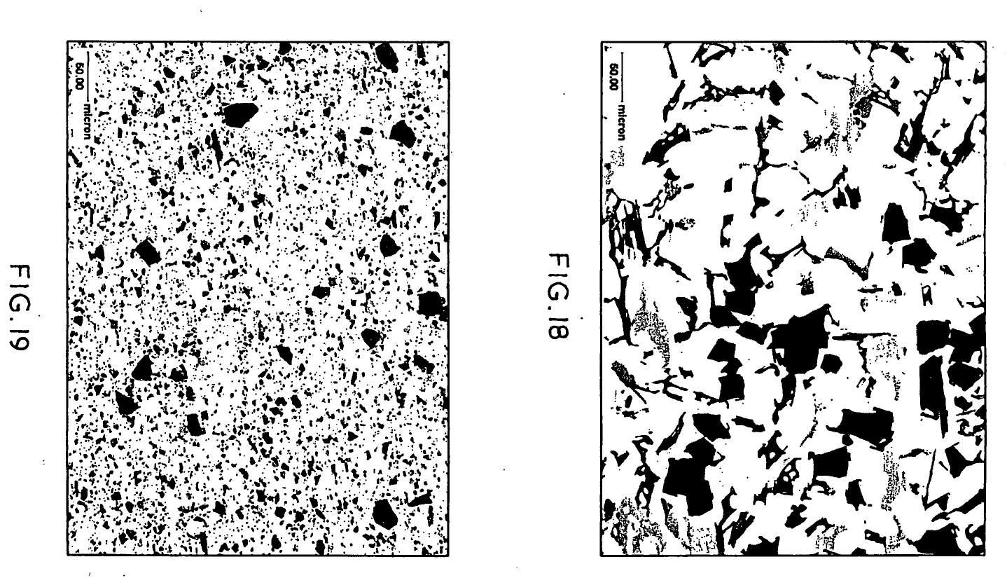

FIGS. 18 and 19 are micrographs, respectively, of the material of a rod used in the first illustrative method before plasticisation and after plasticisation thereof.

All the illustrative methods are methods of manufacturing a piston for use in an internal combustion engine. In each case, the piston defines at least one functional recess having an opening in a surface portion of said piston. In the first, second and third illustrative methods, the method is applied both to a combustion recess and to gudgeon pin-receiving recesses of the piston. In the fourth illustrative method, the method is applied to a piston ring-receiving groove of the piston.

In all the illustrative methods, the piston which is manufactured has a body which is formed from cast metal by conventional methods, and the functional recesses, to which the illustrative methods are applied, each have a surface which is at least partially formed from a property-improving material which is secured to the body. Specifically, the piston which is manufactured has functional recesses in the form of a combustion recess 6 (see eg FIG. 4), two aligned gudgeon pin-receiving recesses 7 (FIG. 4), and a piston ring-receiving groove 8 (FIG. 16).

In each case, the illustrative method comprises forming a blank 10 from cast metal, the blank defining at least one mounting recess which has an opening in a surface portion of the blank. The blank 10 has one mounting recess for each functional recess to which the method is applied. Thus, where the method is applied to a combustion recess 6, the blank 10 has a corresponding mounting recess 12; where the method is applied to two aligned gudgeon pin-receiving recesses 7, the blank 10 has two corresponding mounting recesses 14; and, where the method is applied to a piston ring-receiving groove 8, the blank 10 has a corresponding mounting recess 16 (FIG. 13)

In each case, the illustrative method also comprises securing a quantity of said property-improving material to said blank 10 within said mounting recess 12, 14 or 16, and machining said functional recess 6, 7 or 8 of the piston at least partially out of said quantity of property-improving material. The material forming the blank 10 is designated as 18a, and the property-improving material secured in the recesses 12, 14 and 16 is, respectively, designated 18b, 18c and 18d.

The first illustrative method, illustrated by the FIGS. 1 to 4 of the drawings, comprises forming a blank 10 from an alloy of aluminium containing silicon. The blank 10 has integral portions, 10a, 10b and 10c, arranged, respectively to form a crown portion of the piston, a skirt portion of the piston, and a mounting portion of the piston on which a gudgeon pin (not shown) is mounted. The blank portion 10a defines the mounting recess 12 corresponding to the combustion recess 6. The recess 12 is a blind recess in cylindrical form having a circular opening in an upper surface of the blank 10, a cylindrical side surface 12a, and a circular bottom 12b. The blank portion 10c defines the mounting recesses 14 corresponding to the gudgeon pin-receiving recesses 7. Each recess 14 is a through recess in cylindrical form. Each recess 14 has opposite end openings 14a and a cylindrical side surface 14b. A's the recesses 12 and 14 are all cylindrical they all have circular symmetry about an axis of the recess.

In the first illustrative method, property-improving material 18b and 18c is secured to the blank 10 within each of the recesses 12 and 14, respectively. Specifically, the recess 12 is filled with the material 18b and both of the recesses 14 are filled with the material 18c (see FIG. 3). The process for securing said property-improving material to the blank 10 is essentially the same in each case. The process comprises forming a rod for each recess 12 and 14. In the case of the recess 12 the rod is designated 20 and the two rods associated with the recesses 14 are both designated 22. The rods 20 and 22 are, in each case, formed from a material which on plasticisation under heat and pressure forms said property-improving material 18b or 18c. Specifically, the rods are formed from different aluminium-silicon alloys to the alloy which forms the blank 10, the alloys forming the rods having a relatively coarse grained microstructure (this structure is illustrated by FIG. 18). The property improving material 18b and 18c is formed by refining the microstructure of the alloy forming the rods. Specifically, the alloy forming the rods has a matrix of aluminium grains containing second phase particles which are intermetallic phases and silicon. The refining of the microstructure results in the grain size of the matrix being reduced and also in the reduction in the particle size of the second phase particles (this structure is illustrated by FIG. 19).

The securing process comprises inserting an end of the rod 20 or 22 into said mounting recess 12 or 14, and rotating said rod in contact with a surface of the mounting recess, while applying force to the rod to feed it into the mounting recess. In the case of the recess 12, the rod 20 is inserted through the opening of the recess 12 and is pressed against the bottom 12b. The rod 20 rotates in contact with the bottom 12b and the side surface 12a so that frictional heat is generated. The frictional heat causes plasticisation of the material 18a of the blank and of the rod 20 adjacent to their contact areas. The plasticised material merges across the bottom 12b and the surface 12a and, upon solidification secures the material 18b in the recess 12. The plasticised material fills the gap between the rod 20 and the surface 12a and the layer of plasticised material rises up the recess 12 until the recess is filled with the material 18b which has been plasticised and solidified. When the recess 12 has been filled with the material 18b, the remainder of the rod 20 is withdrawn. The process is essentially the same for the recesses 14 for the material 18c as described above in relation to the recess 12 and the material 18b, but because the recesses 14 are open at both ends, the process is modified and comprises closing one of said openings 14a of each recess 14 with a member 24. The member 24 is selected so that, when said rod 22 is introduced into the mounting recess 14 through the other opening 14a and, while rotating, engages the member 24, frictional heat is generated between the rod and the member but the member is not plasticised. Specifically, the member 24 is positioned in a recess 25 in said mounting portion 10c of the blank so that the member 24 closes openings 14a of both mounting recesses 14 and is engaged on opposite sides by rods 22 in both mounting recesses 14.

During the securing process, the rotational speed of said rods 20 and 22, and the force applied thereto is controlled so that frictional heat is generated which causes plasticisation of the material of the rods 20 and 22, thereby, converting it into said property-improving material 18b and 18c. The heat also causes plasticisation of the material 18a of the blank 10 adjacent to the rods 20 and 22, so that plasticised material of the rods and the blank merge and, upon solidification of the plasticised materials, secure the property-improving material to the blank.

In the first illustrative method, the property improving material 18b is a different alloy of aluminium to the alloy which forms the material 18a from which the blank 10 is made and the material 18c is different from the material 18b, being yet another alloy of aluminium. However, in methods according to the invention, the materials 18b and 18c may be the same, and may be the same as the material 18a since, after the securing process the alloy forming the materials 18b and 18c will have refined microstructure compared with the material 18a.

The first illustrative method also comprises forming the combustion recess 6 out of the material 18b by machining (as shown in FIG. 4). The recess 6 is formed, in this case, entirely out of the material 18b. Also, the first illustrative method comprises forming the gudgeon pin-receiving recesses 14 by machining the material 18c. Specifically, a bore is made through the material 18c.

The second illustrative method is illustrated by FIGS. 5 to 8, it is essentially the same as the first illustrative method except as hereinafter described and the same reference numerals are used for like parts without further description.

The second illustrative method differs from the first illustrative method in that the mounting recesses 12 and 14 have a frusto-conical form, instead of a cylindrical form. Thus, the recesses 14 have wider openings 14a at their distant ends and narrow openings at their adjacent ends, and the recess 12 has a larger opening than its bottom 12b. The frusto-conical surfaces 12a and 14b of the recesses 12 and 14 are provided with ribs 26 to increase the friction between them and the rods 20 and 22. The second illustrative method also differs from the first illustrative method in that end portions of the rods 20 and 22 also have a frusto-conical form to match the form of the recesses 12 and 14, respectively.

The third illustrative method illustrated in FIGS. 9 to 12 is similar to the first illustrative method except as described hereinafter and the same reference numerals are used for like parts without further description. The blank 10 used in the third illustrative method differs from that of the first illustrative method only in the shape of the recess 12 which is, in this case, in the form of a hollow cylinder. Thus, the opening of the recess 12 in the top surface of the crown-forming portion 10a encircles a portion 30 of the material 18a, and the recess 12 has two facing cylindrical side surfaces. In the third illustrative method, the rod 20 is in the form of a hollow cylinder (see FIG. 10) and the combustion recess 6 is machined partially out of the property improving material 18b and partially out of the material 18a of the blank. Specifically, a central portion of the recess 6 is machined out of the material 18a and a rim portion of the recess 6 is machined out of the material 18b.

The third illustrative method also differs from the first illustrative method in the form of the rods 22 which are inserted into the recesses 14. Specifically, each rod 22 is in the form of a hollow cylinder mounted on a core 32 (see FIG. 10). The core 32 is made from a material which does not plasticise at the temperatures reached in the third illustrative method. The core 32 acts to contain the plasticised material during the securing process. As shown in FIG. 10, two cores 32 may be pressed against the member 24 from opposite sides, or the cores 32 may be arranged to be secured to the member 24 when the member 24 is in position in the recess 25, or the two cores 32 may be a continuous piece extending through a passage through the member 24.

The fourth illustrative method illustrated by FIGS. 13 to 16 differs from the first three illustrative methods in that the functional recess to which the method is applied is the piston ring-receiving groove 8 of the piston. In the fourth illustrative method, the blank 10 is formed with the mounting recess 16 and the property-improving material 18d is secured in the recess 16. Specifically, the second material 18c is used as the boundary of the ring groove 8 which extends around the periphery of the piston's side surface adjacent to the top surface of the piston.

The fourth illustrative method comprises forming the mounting recess 16 which is similar to the recess 12 of the third illustrative method but has a greater diameter so that the recess 16 is adjacent to the side surface of the blank 10. The fourth illustrative method comprises securing the property-improving material 18d in the recess 16 by a similar process to that described in relation to the first three illustrative methods but utilising a hollow cylindrical rod 34 having external and internal diameters which correspond to those of the recess 16.

The fourth illustrative method also comprises machining the side surface of said piston crown-forming portion 10a, thereby exposing said property-improving material 18d in said mounting recess 16, and machining the groove 8 at least partially into said exposed material 18d.

FIG. 17 illustrates a modification which may be applied to any of the first to fourth illustrative methods. In this modification, the mounting recesses 12, 14 and 16 are each provided with at least one re-entrant surface portion 50 arranged so that plasticised material enters said re-entrant portion during the securing process so that material solidifed in said re-entrant portion keys said property-improving material into said blank. As illustrated in FIG. 17, the re-entrant surface portions 50 are in the form of annular grooves extending around the recess 12 in the surface 12a thereof, around each of the recesses 14 in the surfaces 14b thereof, and around the recess 16 in the inner cylindrical surface thereof.

It will be apparent that elements of the four illustrative methods and the modification described above can be combined in various permutations. For example, a single piston may have only its combustion recess 12 provided with property-improving material by a method as disclosed in any of the first three illustrative methods, or a single piston may have its combustion recess 12, its gudgeon pin-receiving recesses 14, and its ring-receiving groove 16 provided with property-improving material by a combination of any of the first three illustrative methods with the fourth illustrative method. Furthermore, it will be apparent that the functional recesses 12, 14 and 16 of a single piston may be formed simultaneously or successively.

1-9 (cancelled).

10. A method of manufacturing a piston for use in an internal combustion engine, the piston defining at least one functional recess having an opening in a surface portion of said piston, the piston having a body which is formed from cast metal, the functional recess having a surface which is at least partially formed from a property-improving material which is secured to the body, the method comprising forming a blank from cast metal, the blank defining at least one mounting recess which has an opening in a surface portion of the blank, the method also comprising securing a quantity of said property-improving material to said blank within said mounting recess, and machining said functional recess of the piston at least partially out of said quantity of property-improving material, characterised in that the process for securing said property-improving material to the blank comprises forming a rod from a material which on plasticisation under heat and pressure is formed into said property-improving material, inserting an end of the rod into said mounting recess, and rotating said rod in contact with a surface of the mounting recess, while applying force to the rod to feed it into the mounting recess, the rotational speed of said rod and the force applied thereto being controlled so that frictional heat is generated between the rod and the blank, causing at least partial plasticisation of the material of the rod, thereby converting at least part of the material of the rod into said property-improving material, and also causing plasticisation of the material of the blank adjacent to the rod, so that plasticised material of the rod and the blank merge and secure the property-improving material to the blank.

11. A method according to claim 10, characterised in that the mounting recess is a blind recess of generally cylindrical or frusto-conical form having a circular or annular opening in an end surface of a piston crown-forming portion of the blank.

12. A method according to claim 11, characterised in that the functional recess is a combustion recess of the piston having at least a rim portion thereof machined out of the property-improving material.

13. A method according to claim 11, characterised in that said functional recess is a piston ring-receiving groove of the piston, the method comprising machining a side surface portion of said piston crown-forming portion, thereby exposing said property-improving material in said mounting recess, and machining the groove at least partially into said exposed material.

14. A method according to claim 10, characterised in that the mounting recess is a through recess of generally cylindrical or frusto-conical form having circular openings at either end in side surfaces of a gudgeon pin-mounting portion of the blank, the method comprising at least partially closing one of said openings with a member, the member being selected so that, when said rod is introduced into the mounting recess through the other opening and, while rotating, engages the member, frictional heat is generated between the rod and the member but the member is not plasticised.

15. A method according to claim 14, characterised in that said functional recess is aligned with a similar recess so that these two recesses can together receive a gudgeon pin, said blank defining two aligned mounting recesses and said member being positioned in a recess in said mounting portion of the blank so that the member closes openings of both mounting recesses and can be engaged by rods in both mounting recesses.

16. A method according to claim 10, characterised in that said rod is hollow and includes a core which acts to contain the plasticised material during the securing process.

17. A method according to claim 10, characterised in that said mounting recess is provided with at least one re-entrant surface portion arranged so that plasticised material enters said re-entrant portion during the securing process so that material in said re-entrant portion keys said property-improving material into said blank.

18. A method according to claim 10, characterised in that at least one of the blank and the rod is provided with surface features on their contacting surfaces to increase the friction therebetween.
